(19) United States
(12) Patent Application Publication
(10) Pub. No.: US 2004/0266645 A1
(43) Pub. Date: Dec. 30, 2004

(54) Skin cleansing preparation

(75) Inventors: Harald Albrecht, Hamburg (DE); Petra Koch, Hamburg (DE); Michaela Kohut, Hamburg (DE); Stephan Ruppert, Hamburg (DE)

Correspondence Address: GREENBLUM & BERNSTEIN, P.L.C., 1950 ROLAND CLARKE PLACE, RESTON, VA, 20191, US

(73) Assignee: BEIERSDORF AG, Hamburg (DE)

(21) Appl. No.: 10/849,806

(22) Filed: May 21, 2004

Related U.S. Application Data
(63) Continuation of application No. PCT/EP02/13054, filed on Nov. 21, 2002.

(30) Foreign Application Priority Data
Nov. 23, 2001 (DE) 101 57 541.6

(51) Int. Cl. C11D 3/00

(52) U.S. Cl. 510/395

(57) ABSTRACT

A skin cleansing composition comprising water, a surfactant, a thickener, an abrasive having an average particle size of 75 to 400 μm, and talc having an average particle size of 1 to 20 μm.

### CROSS-REFERENCE TO RELATED APPLICATIONS

The present application is a continuation of International Application No. PCT/EP02/13054, filed Nov. 21, 2002, the entire disclosure whereof is expressly incorporated by reference herein, which claims priority under 35 U.S.C. § 119 of German Patent Application No. 101 57 541.6, filed Nov. 23, 2001.

### BACKGROUND OF THE INVENTION

1. Field of the Invention

The present invention relates to skin cleansing preparations comprising water, surfactants, preservatives, abrasives having an average particle size of 75 μm to 400 μm, talc having a mean particle size of 1 to 20 μm, in addition, if appropriate, to further cosmetic and/or dermatological active ingredients, excipients and additives, their properties and their use.

2. Discussion of Background Information

The desire for clean skin is probably as old as the human race, because dirt, perspiration and remains of dead skin particles offer the ideal breeding ground for pathogens and parasites of all types. The inclination for bodily hygiene has been continuously increased, as in the 20th century in the 60s in addition to “conventional” soap it also became possible to formulate liquid cleansing agents using newly developed synthetic surfactants. Since then we cannot imagine our daily life without baths and showers and today a multitude of products are available to the consumer for cleansing the various parts of the body.

The face cleansing products form a particular group of skin cleansing products here. Since the skin of the face is particularly sensitive, and the face is the most strongly noticed body part and “advertisement” for man, products which are particularly mild and do not irritate the skin are used for cleansing the face. Usually, gels are used here, that is to say semisolid, more or less transparent systems. On account of their composition, however, they often still leave the consumers with an impression of dry, dull skin, which they attempt to decrease by subsequent application of face creams.

For the care of the skin, in particular for the refatting of dry skin, a multitude of products are available which are usually based on emulsions. Emulsions are very finely dispersed oil-in-water or water-in-oil mixtures, which as a rule have a milky-white appearance and a viscous (lotions) to highly viscous (creams) consistency and a creamy feel on dispersing on the skin. Therefore the consumers automatically connect care and protection for the skin with products which possess these properties. An additional cleansing effect can be achieved in these formulations by the presence of abrasives.

It would be desirable to have available a skin cleansing preparation whose appearance, consistency and sensory properties correspond to those of a body care emulsion despite the presence of abrasives.

### SUMMARY OF THE INVENTION

The present invention provides a skin cleansing composition which comprises:

(a) from 70% to 90% by weight of water,

(b) from 0.5% to 10% by weight of one or more surfactants,

(c) from 0.1% to 5% by weight of one or more thickeners,

(d) from 0.1% to 3% by weight of one or more abrasives having an average particle size of from 75 μm to 400 μm, and

(e) from 0.1% to 5% by weight of talc having an average particle size of from 1 to 20 μm.

In one aspect of the composition, the one or more surfactants may comprise an anionic surfactant and/or a cationic surfactant and/or an amphoteric surfactant and/or a non-ionic surfactant.

In another aspect, the one or more surfactants may comprise one or more of a salt of an alkyl ether sulfate, an alkyl polyglucoside, a taurate and an acylglutamate.

In yet another aspect, the one or more surfactants may comprise one or more detergent surfactants having an HLB value of more than 25, e.g., an HLB value of more than 35.

These detergent surfactants may be present in a concentration of, for example, from 0.1% to 10% by weight, or from 0.5% to 10% by weight.

In another aspect of the composition of the present invention, the one or more abrasives may comprise polymethyl methacrylate, silica, polyethylene, boron nitride, nylon, polyurethane, polyester, polyvinyl chloride or any combination thereof. Preferably, the one or more abrasives comprise low-density polyethylene (LDPE) particles.

In yet another aspect of the present composition, the one or more thickeners may comprise one or more gums, e.g., at least one of gum arabic, carob bean flour, tragacanth, Karaya, guar gum, pectin, gellan gum, carrageen, agar, algins, Chondrus, and xanthan gum.

In a still further aspect, the one or more thickeners may comprise at least one of hyaluronic acid, chitin, chitosan, chondroitin sulfate, starch, a starch derivative, methylcellulose, carboxymethylcellulose, hydroxyethylcellulose, and hydroxypropylmethylcellulose. For example, the one or more thickeners may comprise a polyacrylate and/or xanthan gum.

In another aspect, the one or more thickeners may comprise at least a carbopol, preferably at least a carbopol and a xanthan gum. For example, the carbopol and the xanthan gum may be present in a ratio of from 1:0.1 to 1:1.

In a still further aspect, the composition may comprise 0% to less than 1% by weight of a soap.

In another aspect, the composition may have a viscosity of from 2,000 mPas to 8,000 mPas, preferably from 3,000 mPas to 7,000 mPas.

In yet another aspect, the composition may further comprise at least one copolymer, preferably a styrene/acrylate copolymer. For example, the styrene/acrylate copolymer may be present in a concentration of from 0.1% to 5% by weight.

In another aspect, the composition may further comprise an antioxidant, a perfume, a colorant, a buffer system, a glyceride, or any combination thereof. For example, the composition may comprise one or more antioxidants.

The present invention also provides a skin cleansing preparation, a face cleansing preparation and a body cleansing preparation which comprise the composition of the present invention, including the various aspects thereof.

Accordingly, the present invention provides, e.g., skin cleansing preparations comprising

a) water in a concentration of from 70% to 90% by weight,

b) surfactants in a concentration of from 0.5% to 10% by weight,

c) thickeners in a concentration of from 0.1% to 5% by weight,

d) abrasives having an average particle size of from 75 μm to 400 μm in an amount of from 0.1% to 3% by weight,

e) talc having an average particle size of from 1 to 20 μm in an amount of from 0.1% to 5% by weight,

in each case based on the total weight of the preparation, in addition, if appropriate, to further cosmetic and/or dermatological active ingredients, excipients and additives.

Although EP 0101920 describes liquid detergent compositions containing polymer particles and (optionally) talc, this document was unable to point the way to the present invention, since the composition of the formulation cannot be compared with the preparation according to the invention. Even if the positive sensory properties of talc in cosmetic formulations are known (e.g. WO 97/09413) and talc is also described in connection with, inter alia, polyethylene particles (JP 04372700), it would nevertheless not have been obvious to one of skill in the art to arrive at the composition according to the invention, since the formulations described in the above documents contain soaps, which, in particular, are unsuitable for gentle face cleansing and whose employment should therefore be dispensed with. The preparations according to the invention are therefore, soap-free, soap-free within the meaning of the invention denoting a soap content of below 1% by weight based on the total weight of the preparation. Even U.S. Pat. No. 5,534,265 was unable to point the way to the present invention, since it only describes nonabrasive cleansing gels. The particle sizes of the insoluble particles disclosed in U.S. Pat. No. 5,534,265 are between 20 μm to 75 μm and thus in a range where they are no longer sensorily perceptible for the user. In the present invention, however, abrasive particles are employed which have a markedly larger particle diameter. Larger particle diameters demand a correspondingly higher viscosity of the formulation, so that the particles do not sink to the bottom of the preparation pack. This can only be achieved by a completely novel recipe for the formulation.

Advantageous abrasives for use according to the invention include particles of polymethyl methacrylate, silica, polyethylene, boron nitride, nylon, polyurethane, polyester and polyvinyl chloride, and mixtures thereof.

In this case, it is particularly advantageous according to the invention to employ low-density polyethylene particles (LDPE) as abrasives.

The cleansing preparations within the meaning of the present invention comprise talc.

Talc is a widespread hydrated magnesium silicate of the approximate composition Mg₃[(OH)₂/Si₄O₁₀] or 3MgO.4SiO₂, whose denser aggregates are called steatite. Talc forms transparent to nontransparent, mainly colorless, white or pale green, completely cleavable substances, which consist of laminocrystalline, flaky, mica-like aggregates having a mother of pearl luster. Natural talc usually contains traces of other metal oxides. The following composition is thus specified for typical talc: 61% SiO₂, 31% MgO, 5% H₂O, 1.4% Al₂O₃, 1.1% FeO, 0.3% CaO, 0.1% CO₂. Further trace elements which can be present are Mn, Ti, Cr, Ni, Na and K; OH can partly be replaced by F.

Talc having a mean particle size of from 1 to 20 μm in an amount of from 0.1 to 5% by weight can be employed particularly advantageously within the meaning of the present invention.

The cleansing preparations within the meaning of the present invention further advantageously may contain one or more detergent surfactants of the following four groups A to D:

A. Anionic Surfactants

Anionic surfactants which can be used advantageously include acylamino acids (and their salts), such as

1. Acylglutamates, for example sodium acylglutamate, di-TEA palmitoylaspartate and sodium caprylic/capric glutamate,

2. Acylpeptides, for example palmitoyl hydrolyzed milk protein, sodium cocoyl hydrolyzed soybean protein and sodium/potassium cocoyl hydrolyzed collagen,

3. Sarcosinates, for example myristoyl sarcosine, TEA lauroyl sarcosinate, sodium lauroyl sarcosinate and sodium cocoyl sarcosinate,

4. Taurates, for example sodium lauroyl taurate and sodium methylcocoyl taurate,

carboxylic acids and derivatives, such as

1. Carboxylic acids, for example lauric acid, aluminum stearate, magnesium alkanolate and zinc undecylenate,

2. Ester carboxylic acids, for example calcium stearoyllactylate, laureth-6 citrate and sodium PEG-4 lauramidecarboxylate,

3. Ether carboxylic acids, for example sodium laureth-13 carboxylate and sodium PEG-6 cocamide carboxylate,

phosphoric acid esters and salts, such as, for example, DEA-oleth-10 phosphate and dilaureth-4 phosphate,

sulfonic acids and salts, such as

1. Acyl isethionates, e.g. sodium/ammonium cocoyl isethionate,

2. Alkylarylsulfonates,

3. Alkylsulfonates, for example sodium coconut monoglyceride sulfate, sodium C₁₂₋₁₄ olefin sulfonate, sodium lauryl sulfoacetate and magnesium PEG-3 cocamide sulfate,

4. Sulfosuccinates, for example dioctylsodium sulfosuccinate, disodium laureth sulfosuccinate, disodium lauryl sulfosuccinate and disodium undecylenamido MEA-sulfosuccinate,

and

sulfuric acid esters, such as

1. Alkyl ether sulfate, for example sodium, ammonium, magnesium, MIPA, TIPA laureth sulfate, sodium myreth sulfate and sodium C₁₂₋₁₃ pareth sulfate,

2. Alkylsulfates, for example sodium, ammonium and TEA lauryl sulfate.

B. Cationic Surfactants

Cationic surfactants which can advantageously be used are

1. Alkylamines,

2. Alkylimidazoles,

3. Ethoxylated amines and

4. Quaternary surfactants.

Quaternary surfactants contain at least one N atom, which is covalently bonded to 4 alkyl or aryl groups. This leads, independently of the pH, to a positive charge. Benzalkonium chloride, alkylbetaine, alkylamidopropylbetaine and alkylamidopropylhydroxysultaine are advantageous.

C. Amphoteric Surfactants

Amphoteric surfactants which can advantageously be used include

1. Acyl/dialkylethylenediamine, for example sodium acylamphoacetate, disodium acylamphodipropionate, disodium alkylamphodiacetate, sodium acylamphohydroxypropylsulfonate, disodium acylamphodiacetate and sodium acylamphopropionate,

2. N-Alkylamino acids, for example aminopropylalkylglutamide, alkylaminopropionic acid, sodium alkylimidodipropionate and lauroamphocarboxyglycinate.

3. N-Alkyl- or N-alkenylbetaines having at least 12 C atoms, such as, for example, laurylamidopropylbetaine and oleylamidopropylbetaine.

D. Nonionic Surfactants

Nonionic surfactants which can advantageously be used include

1. Alcohols,

2. Alkanolamides, such as cocamides MEA/DEA/MIPA,

3. Amine oxides, such as coconut amidopropylamine oxide,

4. Esters which can be formed by esterification of carboxylic acids with ethylene oxide, glycerol, sorbitan or other alcohols,

5. Ethers, for example ethoxylated/propoxylated alcohols, ethoxylated/propoxylated esters, ethoxylated/propoxylated glycerol esters, ethoxylated/propoxylated cholesterols, ethoxylated/propoxylated triglyceride esters, ethoxylated propoxylated lanolin, ethoxylated/propoxylated polysiloxanes, propoxylated POE ethers and alkyl polyglycosides such as lauryl glucoside, decyl glycoside and coconut glycoside.

6. Sucrose esters, sucrose ethers

7. Polyglycerol esters, diglycerol esters, monoglycerol esters

8. Methylglucose esters, esters of hydroxy acids.

The cleansing preparations according to the present invention particularly advantageously contain one or more detergent surfactants from the group of surfactants which have an HLB of more than 25, very particularly those which have an HLB of more than 35.

It is advantageous within the meaning of the present invention if the content of one or more detergent surfactants in the cosmetic or dermatological cleansing preparation is from 0.1 to 10% by weight, very particularly advantageously from 0.5 to 5% by weight, in each case based on the total weight of the preparation.

It is particularly advantageous according to the invention if salts of the alkyl ether sulfates, alkyl polyglucosides, taurates and acylglutamates are employed as surfactants.

It is further advantageous according to the invention if thickeners are employed in the skin cleansing preparations according to the invention. These can, for example, advantageously be selected from the group of the gums.

The gums include plant or tree saps which harden in air and form resins or extracts of aquatic plants. From this group, it is possible within the meaning of the present invention to advantageously choose, for example, gum arabic, carob bean flour, tragacanth, Karaya, guar gum, pectin, gellan gum, carrageen, agar, algins, Chondrus, xanthan gum.

The use of derivatized gums such as, for example, hydroxypropyl guar (Jaguar® HP 8) is furthermore advantageous.

Among the polysaccharides and polysaccharide derivatives advantageous thickeners according to the invention are found to be, for example, hyaluronic acid, chitin and chitosan, chondroitin sulfates, starch and starch derivatives.

Among the cellulose derivatives advantageous thickeners according to the invention are found to be, for example, methylcellulose, carboxymethylcellulose, hydroxyethylcellulose, hydroxypropylmethylcellulose.

Among the layer silicates are found naturally occurring and synthetic argillaceous earths such as, for example, montmorillonite, bentonite, hectorite, laponite, magnesium aluminum silicates such as Veegum®. These can be used as thickeners as such or in modified form such as, for example, stearylalkonium hectorites.

Furthermore, silica gels can advantageously also be used.

Among the polyacrylates are found, for example, carbopol types from Goodrich (Carbopol 980, 981, 1382, 5984, 2984, ETD 2001, ETD 2020, ETD 2050 or Pemulen TR1 & TR2).

Among the polymers are found, for example, polyacrylamides (Seppigel 305), polyvinyl alcohols, PVP, PVP/VA copolymers, polyglycols.

The particularly preferred thickeners according to the invention are carbopols and xanthan gum, in particular the combination of carbopols with xanthan gum in a ratio of from 1:0.1 to 1:1.

Advantageous preservatives within the meaning of the present invention are, for example, formaldehyde liberating agents (such as, for example, DMDM hydantoin, which is obtainable, for example, under the trade name Glydant™ from Lonza), iodopropyl butylcarbamates (e.g. those obtainable under the trade names Glycacil-L, Glycacil-S from Lonza and/or Dekaben LMB from Jan Dekker), parabens (i.e. alkyl p-hydroxybenzoates, such as methyl-, ethyl-, propyl- and/or butylparaben), phenoxyethanol, ethanol, benzoic acid and suchlike. Customarily, according to the invention the preservation system further advantageously also comprises preservation aids, such as, for example, octoxyglycerol, Glycine soja etc.

The preparations according to the invention can furthermore contain copolymers. In this case, styrene/acrylate copolymers are advantageous according to the invention, in particular in concentrations of from 0.1% to 5% by weight.

In addition, excipients and additives which are customary in cosmetics can be incorporated into the formulations according to the invention, for example

antioxidants

perfume

colorants

buffer systems

glycerides.

According to the invention, the preparations advantageously contain one or more antioxidants. As favourable antioxidants, which, however, are nevertheless to be used optionally, it is possible to use all antioxidants which are suitable or customary for cosmetic and/or dermatological applications.

Particularly advantageously, within the meaning of the present invention water-soluble antioxidants can be employed, such as, for example vitamins, e.g. ascorbic acid and its derivatives.

Preferred antioxidants are furthermore vitamin E and F and their derivatives, and vitamin A and its derivatives.

The amount of the antioxidants (one or more compounds) in the preparations is preferably from 0.001% to 30% by weight, particularly preferably from 0.05% to 20% by weight, in particular from 0.1% to 10% by weight, based on the total weight of the preparation.

If vitamin E and/or its derivatives are the antioxidant(s), it is advantageous to choose their respective concentrations from the range from 0.001% to 10% by weight, based on the total weight of the formulation.

If vitamin A or vitamin A derivatives, and carotenes or their derivatives are the antioxidant(s), it is advantageous to choose their respective concentrations from the range from 0.001% to 10% by weight, based on the total weight of the formulation.

It is particularly advantageous if the cosmetic preparations according to the present invention contain cosmetic or dermatological active ingredients, preferred active ingredients being antioxidants which can protect the skin from oxidative stress.

The present skin cleansing preparations can moreover contain active ingredients. In this case, the following active ingredients are particularly advantageous according to the invention: α-flavones, in particular α-glycosylrutin, biotin, retinols, ceramides, vitamins and/or ubiquinone, in particular coenzyme Q 10, and/or their derivatives.

This list is, of course, non-limiting.

It can furthermore be advantageous to add color particles, e.g. beads of active ingredients, to the skin cleansing preparation according to the invention. By means of incorporated color pigments, gas bubbles and the like, or else also by means of relatively large objects and color streaks, the skin cleansing preparations according to the invention can be made visually interesting in a form which is advantageous according to the invention.

Gel-like skin cleansing preparations which possess the appearance, the viscosity and the skin sensitivity of a lotion are moreover novel.

The term “viscosity” is understood as meaning the property of a liquid of putting up a resistance (glutinousness, internal friction) to the mutual laminar displacement of two adjacent layers. Today, this “dynamic viscosity” is defined according to η=τ/D as the ratio of the shear stress to the velocity gradient perpendicular to the flow direction. For Newtonian liquids, η at a given temperature is a substance constant having the Si unit Pascal second (Pa•s).

The quotient ν=η/ρ of the dynamic viscosity η and the density ρ of the liquid is designated as the kinematic viscosity ν and stated in the SI unit m²/s.

The reciprocal of the viscosity (φ=1/η) is designated as the fluidity (φ). In the case of ointments and the like, the utility value, inter alia, of the “ductility” is codetermined. The ductility of an ointment or ointment base or the like is understood as meaning its property of drawing threads of varying length on separating; accordingly, a distinction is made between low-ductility and high-ductility substances.

While the graphical representation of the flow behaviour of Newtonian liquids at a given temperature affords a straight line, “non-Newtonian liquids”, depending on the respective velocity gradient D (shear rate \dot{γ}) or the shear stress τ, often show considerable deviations. In these cases, the “apparent viscosity” can be determined, which admittedly does not obey the Newtonian equation, but from which the true viscosity values can be determined by graphical procedures.

Falling body viscometry is only suitable for the investigation of Newtonian liquids and of gases. It is based on Stokes' law, according to which, for the fall of a sphere through a liquid flowing around it, the dynamic viscosity η is determinable from

$$η = \frac{2 {r}^{2} ( {ρ}_{K} - {ρ}_{FI} ) \cdot g}{9 \cdot v}$$

where

r=radius of the sphere, σ=rate of fall, ρ_{K}=density of the sphere, ρ_{FI}=density of the liquid and g=gravitational acceleration.

The viscosity values of the preparations and individual substances mentioned in the context of the present specification were determined with the aid of a viscometer of the type Viskotester VT 02 from the company Haake.

Within the meaning of the present invention, skin cleansing preparations are preferred which have a viscosity of 2,000 mPas to 8,000 mPas.

Particularly preferably, the viscosity is in the range from 3,000 mPas to 7,000 mPas.

The skin cleansing preparations according to the invention can be used as face and/or body cleansing compositions.

### DETAILED DESCRIPTION OF THE INVENTION

The following examples are intended to illustrate the present invention without restricting it. All quantitative data, proportions and percentages are, if not stated otherwise, based on the weight and the total amount or on the total weight of the preparations.

### RECIPE EXAMPLES

| | 1 | 2 | 3 | 4 | 5 |
|---|---|---|---|---|---|
| Sodium cocoylglutamate | — | — | — | 0.5 | 0.5 |
| Disodium lauryl polygly- | — | — | 0.1 | — | 0.1 |
| col ether sulfosuccinate | | | | | |
| Decyl glucoside | — | 0.5 | 0.25 | — | — |
| Sodium lauryl ether | 2.0 | — | 1.5 | 2.0 | — |
| sulfate | | | | | |
| Sodium myristyl ether | — | 1.5 | — | — | 1.0 |
| sulfate | | | | | |
| Sodium methylcocoyl- | 0.6 | 0.5 | 0.3 | 0.6 | — |
| taurate | | | | | |
| Glycerol | 2.0 | 2.0 | 1.0 | 2.0 | — |
| Sodium carbomer | 1.2 | 1.2 | 1.0 | 1.2 | 1.0 |
| Styrene/acrylate co- | 2.0 | 2.5 | 2.0 | 1.0 | 1.0 |
| polymer | | | | | |
| Xanthan gum | 0.25 | 0.25 | 0.2 | 0.25 | 0.3 |
| Polyethylene | 1.0 | 1.0 | 0.75 | 0.75 | 0.75 |
| Talc | 1.0 | 1.0 | 1.0 | 1.5 | 0.5 |
| PEG-40 hydrogenated | — | — | — | 0.5 | 1.0 |
| castor oil | | | | | |
| PEG-7 glyceryl cocoate | 0.5 | — | 0.5 | 0.5 | — |
| Parabens | 0.2 | 0.2 | 0.15 | 0.15 | 0.15 |
| EDTA | — | — | — | 0.1 | 0.2 |
| Benzophenone-3 | 0.05 | 0.05 | 0.04 | 0.03 | 0.03 |
| Methyldibromoglutaro- | 0.05 | 0.05 | 0.04 | 0.05 | — |
| nitrile | | | | | |
| Phenoxyethanol | 0.6 | 0.6 | 0.5 | 0.35 | 0.35 |
| Perfume | q.s. | q.s. | q.s. | q.s. | q.s. |
| Water | to 100 | to 100 | to 100 | to 100 | to 100 |

What is claimed is:

1. A skin cleansing composition comprising
(a) from 70% to 90% by weight of water,
(b) from 0.5% to 10% by weight of one or more surfactants,
(c) from 0.1% to 5% by weight of one or more thickeners,
(d) from 0.1% to 3% by weight of one or more abrasives having an average particle size of from 75 μm to 400 μm,
(e) from 0.1% to 5% by weight of talc having an average particle size of from 1 to 20 μm.

2. The composition of claim 1, wherein the one or more surfactants comprise an anionic surfactant.

3. The composition of claim 1, wherein the one or more surfactants comprise a cationic surfactant.

4. The composition of claim 1, wherein the one or more surfactants comprise an amphoteric surfactant.

5. The composition of claim 1, wherein the one or more surfactants comprise a non-ionic surfactant.

6. The composition of claim 1, wherein the one or more surfactants comprise at least one of a salt of an alkyl ether sulfate, an alkyl polyglucoside, a taurate and an acylglutamate.

7. The composition of claim 1, wherein the one or more surfactants comprise one or more detergent surfactants having an HLB value of more than 25.

8. The composition of claim 7, wherein the one or more surfactants comprise one or more detergent surfactants having an HLB value of more than 35.

9. The composition of claim 7, wherein the one or more detergent surfactants are present in a concentration of from 0.1% to 10% by weight.

10. The composition of claim 8, wherein the one or more detergent surfactants are present in a concentration of from 0.5% to 10% by weight.

11. The composition of claim 1, wherein the one or more abrasives comprise at least one of polymethyl methacrylate, silica, polyethylene, boron nitride, nylon, polyurethane, polyester and polyvinyl chloride.

12. The composition of claim 11, wherein the one or more abrasives comprise low-density polyethylene (LDPE) particles.

13. The composition of claim 1, wherein the one or more thickeners comprise one or more gums.

14. The composition of claim 13, wherein the one or more gums comprise at least one of gum arabic, carob bean flour, tragacanth, Karaya, guar gum, pectin, gellan gum, carrageen, agar, algins, Chondrus, and xanthan gum

15. The composition of claim 1, wherein the one or more thickeners comprise at least one of hyaluronic acid, chitin, chitosan, chondroitin sulfate, starch, a starch derivative, methylcellulose, carboxymethylcellulose, hydroxyethylcellulose, and hydroxypropylmethylcellulose.

16. The composition of claim 1, wherein the one or more thickeners comprise at least one of a polyacrylate and xanthan gum.

17. The composition of claim 16, wherein the one or more thickeners comprise at least a carbopol.

18. The composition of claim 17, wherein the one or more thickeners comprise at least a carbopol and a xanthan gum.

19. The composition of claim 18, wherein the carbopol and the xanthan gum are present in a ratio of from 1:0.1 to 1:1.

20. The composition of claim 1, wherein the composition comprises 0% to less than 1% by weight of a soap.

21. The composition of claim 1, wherein the composition has a viscosity of from 2,000 mPas to 8,000 mPas.

22. The composition of claim 20, wherein the composition has a viscosity of from 3,000 mPas to 7,000 mPas.

23. The composition of claim 21, wherein the composition further comprises at least one copolymer.

24. The composition of claim 23, wherein the at least one copolymer comprises a styrene/acrylate copolymer.

25. The composition of claim 24, wherein the styrene/acrylate copolymer is present in a concentration of from 0.1% to 5% by weight.

26. The composition of claim 1, wherein the composition further comprises at least one of an antioxidant, a perfume, a colorant, a buffer system and a glyceride.

27. The composition of claim 26, wherein the composition further comprises one or more antioxidants.

28. A skin cleansing composition comprising
(a) from 70% to 90% by weight of water,
(b) from 0.5% to 10% by weight of one or more surfactants which comprise at least one of a salt of an alkyl ether sulfate, an alkyl polyglucoside, a taurate and a acylglutamate,
(c) from 0.1% to 5% by weight of one or more thickeners which comprise at least a carbopol and a xanthan gum,
(d) from 0.1% to 3% by weight of one or more abrasives having an average particle size of from 75 μm to 400 μm and comprising low-density polyethylene (LDPE) particles,
(e) from 0.1% to 5% by weight of talc having an average particle size of from 1 to 20 μm,
wherein the composition has a viscosity of from 3,000 mPas to 7,000 mPas and comprises 0% to less than 1% by weight of a soap.

29. The composition of claim 28, wherein the composition further comprises a styrene/acrylate copolymer in a concentration of from 0.1% to 5% by weight.

30. A skin cleansing preparation which comprises the composition of claim 1.

31. A face cleansing preparation which comprises the composition of claim 1.

32. A body cleansing preparation which comprises the composition of claim 1.
